(19) United States
(12) Patent Application Publication
(10) Pub. No.: US 2012/0262917 A1
(43) Pub. Date: Oct. 18, 2012

(54) ENERGY EFFICIENT STREET LIGHTING LED LUMINAIRE

(76) Inventor: Guy Courcelle, Mont-Saint-Hilaire (CA)

(21) Appl. No.: 13/446,523

(22) Filed: Apr. 13, 2012

Related U.S. Application Data
(60) Provisional application No. 61/475,952, filed on Apr. 15, 2011.

(51) Int. Cl. F21V 5/04; F21V 29/00; F21V 17/10; F21V 31/00; F21V 31/03; F21V 21/00; F21V 17/12

(52) U.S. Cl. 362/235; 362/249.05

(57) ABSTRACT

An energy-efficient street luminaire includes a luminaire housing having a heat sink in the form of outwardly extending fins integrally formed with the luminaire housing and abutting an LED junction. The luminaire also includes an LED array housed within the luminaire housing and an optical system with a high transmittance glass surrounding the LED array and the LED junction providing for the effective transmission of light generated by the LED array. An electronic driver is coupled to the LED arrays for controlling the transmission of electricity thereto.

### CROSS REFERENCE TO RELATED APPLICATION

This application claims the benefit of U.S. Provisional Patent Application Ser. No. 61/475,952, entitled “ENERGY EFFICIENT STREET LIGHTING LED LUMINAIRE,” filed Apr. 15, 2011.

### BACKGROUND OF THE INVENTION

1. Field of Invention

The invention relates to street lighting LED luminaires.

2. Description of the Related Art

LED products for street lighting have been appearing on the market continuously. So far, most of the high power light emitting diode (LED) luminaires have created many problems. As a result, a fast penetration of the market has been difficult and these low quality products have hurt the lighting industry. The challenges that come with the use of LED light sources affect experienced and new lighting manufacturers. In the past, each step of a luminaire design could be undertaken separately. It is completely different when applying LED technology to the production of luminaires.

Currently, there are two major principles in LED lighting. One technique consists in assembling a series of single LEDs on a circuit board, each of the diodes is linked to an individual lens called a collimator, allowing for light to be distributed. This technology is referred to as MULTI-LED. In this technique, the LEDs are often integrated permanently into the fixture, making their replacement difficult or impossible.

The second technique uses a matrix of LEDs or LED Arrays with integrated solid-state light sources enabling high performance and energy-efficient products by combining an optical system mainly based on reflexion principles. This technology is referred to as arrays of MULTI-CHIP.

To correct the mentioned problems, the present invention provides a new energy efficient street lighting by supplying true Illuminating Engineering Society (IES) distribution patterns and meeting the lighting levels specified by the Illuminating Engineering Society of North America for major, collector and local streets. This is achieved with the selection of a reliable LED supplier, and a state-of-the art luminaire design ensuring the management of the LED junction temperature. The equilibrium between these two actions is accomplished by the creation of an intelligent street lighting system luminaire with a high luminous efficacy.

### SUMMARY OF THE INVENTION

It is, therefore, an object of the present invention to provide an energy-efficient street luminaire including a luminaire housing having a heat sink in the form of outwardly extending fins integrally formed with the luminaire housing and abutting an LED junction. The luminaire also includes an LED array housed within the luminaire housing and an optical system with a high transmittance glass surrounding the LED array and the LED junction providing for the effective transmission of light generated by the LED array. An electronic driver is coupled to the LED arrays for controlling the transmission of electricity thereto.

It is also an object of the present invention to provide a luminaire wherein the LED array and the LED junction are mounted within an optical chamber that fits within the luminaire housing.

It is another object of the present invention to provide a luminaire wherein the LED junction in the optical chamber abuts the inner surface of the heat sink.

It is a further object of the present invention to provide a luminaire wherein the optical chamber includes an aluminum plate secured to an inner wall of the luminaire housing along a forward cavity section, which coincides with an inner surface of the heat sink.

It is also an object of the present invention to provide a luminaire wherein the aluminum plate conforms with a shape of the inner wall of the luminaire housing.

It is another object of the present invention to provide a luminaire wherein the LED array and LED junction are screwed directly onto apertures formed in the aluminum plate and into apertures formed in the luminaire housing so as to creating a facing relationship with the heat sink.

It is a further object of the present invention to provide a luminaire wherein the optical chamber is an airtight component including a waterproof glass cover or protective optical lens.

It is also an object of the present invention to provide a luminaire wherein the optical chamber is hermetically sealed permitting management of air in the optical chamber.

It is another object of the present invention to provide a luminaire wherein the LED array is a MULTICHIP MONOLED.

It is a further object of the present invention to provide a luminaire wherein the luminaire housing is a general concave structure with a top wall and downwardly extending side walls, and includes a forward cavity section housing an optical chamber, the LED array, the LED junction, the optical system and a high transmittance glass.

It is also an object of the present invention to provide a luminaire wherein the forward cavity section of the luminaire housing is separated from a rearward cavity section by an optical separation wall.

It is another object of the present invention to provide a luminaire wherein the rearward cavity section is provided with rib lattice and lateral reinforced wall section.

It is a further object of the present invention to provide a luminaire wherein the rib lattice and lateral reinforced wall section provide for the transfer of combined forces in three directions to a clamping mechanism used in securing the luminaire to the support pole or mast.

It is also an object of the present invention to provide a luminaire wherein the forward cavity section is provided with rib lattice to enhance the strength characteristics thereof.

It is another object of the present invention to provide a luminaire wherein the luminaire housing and a cover are constructed of 22 ksi yield strength cast aluminum alloy, resisting 5 g forces.

It is a further object of the present invention to provide a luminaire wherein the heat sink is structured as fins extending outwardly from a primary body of the luminaire housing, and connected ends of the fins share an inner wall of the luminaire housing allowing for effective heat transfer.

It is also an object of the present invention to provide a luminaire including a cover made in two parts.

It is another object of the present invention to provide a luminaire wherein the cover includes an optical door frame secured to an open end of the luminaire housing adjacent a forward cavity section of the housing and a hinged door secured to the open end of the luminaire housing adjacent the rearward cavity section, wherein the optical door frame and the hinged door fully cover forward and rearward cavity sections of the luminaire housing.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a side view of the housing for the present LED luminaire showing the photocell location and the heat exchange fins.

FIG. 2 is a top plan view of the housing depicted in FIG. 1 showing the photocell location and the heat exchange.

FIG. 3 is a front view of the housing depicted in FIG. 1 showing the photocell location and the heat exchange fins.

FIG. 4 is a back view of the housing depicted in FIG. 1 showing the photocell location and the heat exchange fins according to the present invention.

FIG. 5 shows details of the internal structure of the housing according to the present invention.

FIG. 6 is an exploded view showing the post mounting plate, the housing main body, the electrical assembly, the optical chamber, hinged door and the optical door frame of the LED luminaire.

FIGS. 7A, 7B and 7C show a fully assembled LED luminaire with all components used in the present invention.

FIGS. 8, 8A and 8B are respectively a perspective view, an exploded view and a cross sectional view of the mandrel described for use in securing the LED luminaire to a post mast.

FIGS. 9A, 9B and 9C respectively show a top view, a perspective view and a rear view of the aluminum V-shaped plate screwed into the upper section of the housing in the optical chamber compartment in order to increase the LEDs heat dissipation.

FIGS. 10A and 10B are respectively a side view and a perspective view of the hinged door.

FIG. 11 shows various light distribution patterns that may be achieved using the present LED luminaire.

FIG. 12 is a table explaining Ingress Protection rating nomenclature.

FIG. 13 is a graphical representation showing the depreciation of illumination time for lighting systems with maintenance every three years.

FIG. 14 is a graphical representation demonstrating light loss factors.

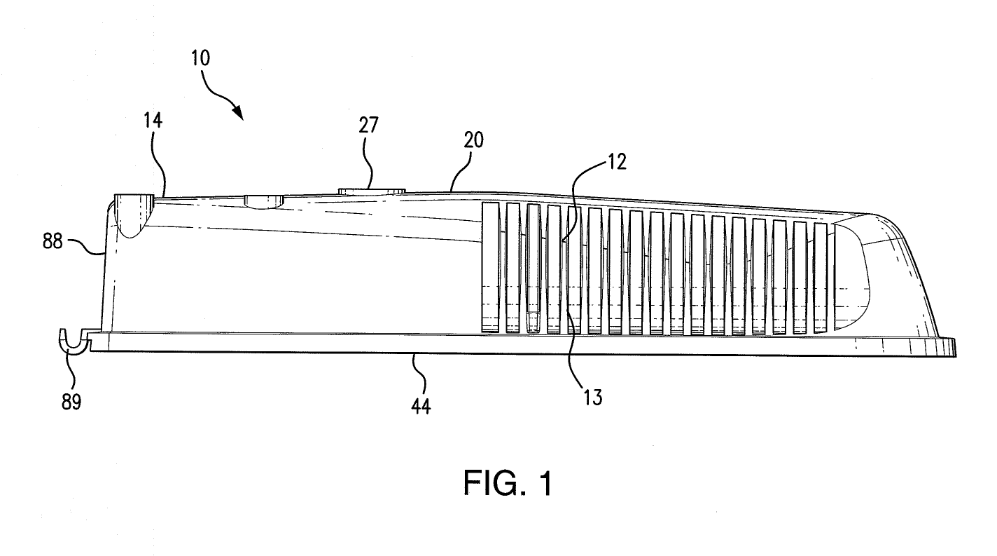

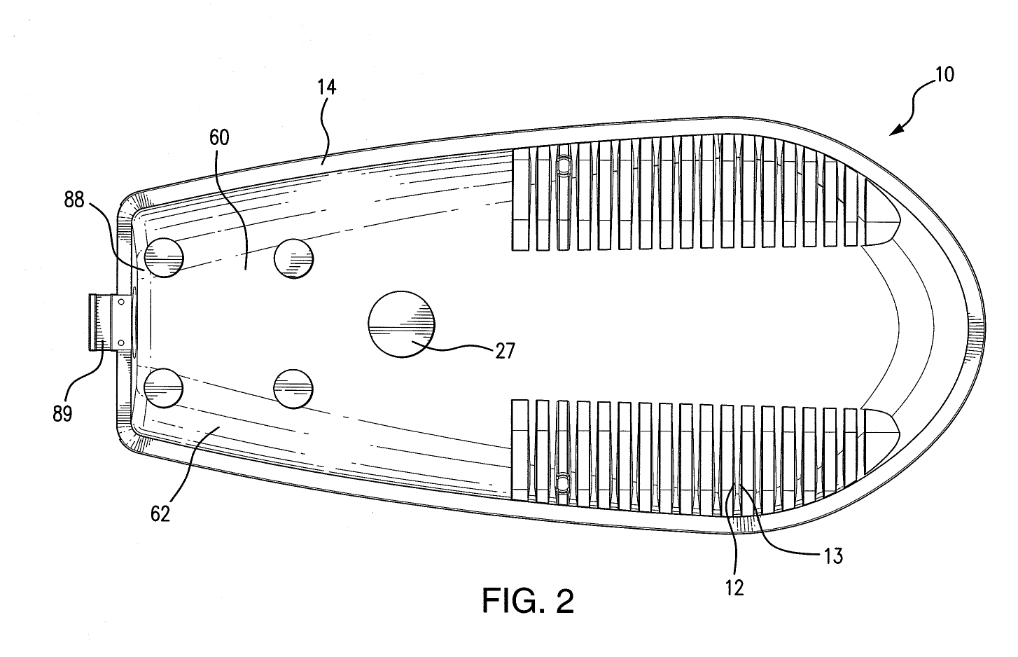

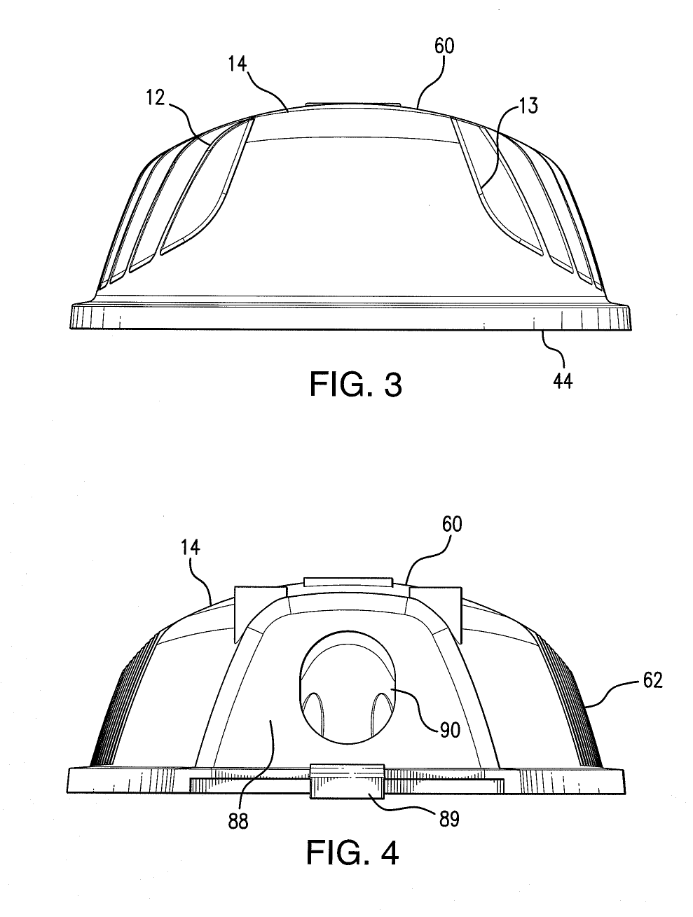

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

In accordance with the present invention, and with reference to the various figures, an energy-efficient street LED luminaire 10 is disclosed. The LED luminaire 10 employs LED arrays manufactured according to specification to ensure sufficient quantity of light, high luminous efficacy, and a high color rendering index in a range of correlated color temperatures and color consistency.

The binning of LEDs is a practice used by LED manufacturers to manage the variation of LED performance in mass production processes. Binning refers to the classification of production yields. An LED manufacturing production process involves the steps of making semiconductor wafers, of adding epitaxial layers, of adding metal contacts, of mounting and finally packaging. Some of the processing steps can be automated, but not all are automated. The coating processes (epitaxial growth and phosphors) create significant inherent variations that impact the total luminous flux and the colorimetric properties (color temperature and color rendering index).

Even with all of the research & development efforts spent by the LED manufacturers to minimize their production variations, the end result is that the overall production process is not capable of highly consistent and tightly controlled production of LEDs. In an effort to maximize yields, LED manufacturers sort their production into lumen bins, color bins and sometimes voltage bins. Lumen bins categorize LEDs based upon the minimum and maximum values of the total luminous flux of an LED with its tolerance. Color bins provide separation for variations in optical wavelength or color temperature. Voltage bins divide components according to variations of their forward voltage rating.

Binning is important for luminaire manufacturers to specify and control since it has serious implications on performance. The inefficiencies of binning may create structural vulnerability in the performance of an LED luminaire. Accordingly, LED suppliers are selected based upon their binning specification product being considerably smaller than the ANSI (American National Standards Institute) standard bin size.

LED is the common abbreviation for a light emitting diode. The term SSL for Solid-State Lighting is also commonly used to designate an LED source. An LED is a semiconductor that emits light when a forward voltage is applied. LED light sources are very sensitive to heat. They are, however, very different from traditional light sources because they radiate a minimal amount of heat energy. This is a major advantage because heat is not produced in the LED illuminated area, but instead it is produced at the LED junction. As will be appreciated based upon the following disclosure, the present LED luminaire 10 conducts wasted thermal energy absorbed into the LED away from the LED through heat sinks 12 incorporated in the luminaire housing 14. In accordance with a preferred embodiment, the heats sinks 12 are outwardly extending fins integrally formed with the luminaire housing 14.

The present LED luminaire 10 employs MULTI-CHIP LED arrays 16 combined with a different optical system which allows for the selective replacement of traditional lamps with the present efficient street LED luminaire 10. This replacement is possible regardless of the type of lighting source lamp, for example, Mercury Vapor, Low Pressure Sodium, or High Pressure Sodium and Metal Halide, used by traditional street cobra head light fixtures. Still further, replacement with the present LED luminaire 10 does not require adjustment or customization of the existing infrastructures (whether in regards to the mounting height and the existing pole spacing that are currently installed).

The lighting principles of the present LED luminaire 10 combine LED technology with the incorporation of a collection of LED arrays in a printed circuit (referred to as a “MULTI-CHIP LED”) allowing for the minimization of the original surface used by the light source. As a consequence, the lighting principles that have directed the lighting sector are respected, for instance, a point as the source of light. The smaller and the more precise the light source in a reflector, the more likely the reflector will return an equally accurate and precise lighting distribution.

The present LED luminaire 10 uses high power MULTI-CHIP LED arrays 16 and a reflector 18 to distribute the light. The real lifetime and performance of the MULTI-CHIP LEDs are directly linked to the operating LED junction 17 temperature controlled by the heat sinks 12 incorporated into the housing 14. The overall performance of the luminaire 10 depends on each and every one of these components.

Since the thermal limits of an LED are similar to a silicon device and the LED life will be reduced roughly by half for every 10° Celsius that exceeds the nominal value of the LED junction temperature, the present energy efficient street lighting LED luminaire 10 is designed in such a manner that the LED operating junction temperature be kept much less than the nominal value specified by the LED manufacturer to ensure a longer life.

The present LED luminaire 10 replaces traditional street luminaires with integrated solid-state light sources enabling high performance and energy-efficient products for major, collector and local street types. The present street lighting LED luminaire 10 meets the lighting levels and uniformity ratios specified by the Illuminating Engineering Society of North America (IESNA), and provides many benefits in terms of the quality of light. Contrary to traditional luminaires, which allowed for the easy interchange of its principal parts, each LED luminaire 10 is unique and every change to one of its parts automatically results in the creation of a different LED luminaire with different performance characteristics.

The present energy efficient LED luminaire 10 improves driver safety in all types of street lighting applications and respects the physiological and physical tendencies in traditional lights, while acknowledging that lighting through a traditional light source and a light emitting diode light source are completely and fundamentally different, requiring many integrations and interrelations between different components of the luminaires.

While lifetimes of traditional light sources cause high maintenance costs in street lighting, the present LED luminaire 10 changes several aspects of this traditional approach due to the fact that LEDs usually do not fail abruptly like traditional light sources and their light output slowly diminishes over time. LED light sources can have such long lives that the maintenance costs are reduced substantially. Finally, the reinforced quality of the light by using proper color characteristics can be adapted to different pavement types (asphalt and cement concrete road surfaces).

Bearing in mind that the introduction of the LED technology will overturn many established standards, the present LED luminaire 10 provides for unique characteristics to meet this new technological challenge, allowing innovation in each of the principal component domains. For example, while respecting the oval shape and offering a smooth top, the housing 14 incorporates a series of vertical external heat sinks 12 on each of its sides in order to facilitate the thermal management of the LED light sources. The main components of the present LED luminaire 10 are multiple LED arrays 16 housed within a die-cast housing 14 with integrated heat sinks 12. The LED luminaire 10 also includes an optical system in the form of an optical chamber 29 combined to a high transmittance glass 22 surrounding the LED arrays 16 and providing for the effective transmission of lighted generated by the LED arrays 16. The housing 14 is further provided with a multifunctional clamping mechanism 24 allowing for controlled and secure attachment of the LED luminaire 10 to a post mast or other support structure. The LED luminaire 10 is also provided with one or two electronic driver(s) 26, coupled to a photodetector 27, and a surge protector unit 28 coupled to the LED arrays 16 for controlling the transmission of electricity thereto. The functionality of each of these components is described below.

### LED Arrays

As discussed above, an LED is a semiconductor that emits light when a forward voltage is applied to it. Since the performance of the LED arrays 16 in terms of lumen output tends to increase with color rendering index improvement and reduced correlated color temperature binning complexity, the LED support mounting is designed to facilitate fast replacement of the LED arrays 16 to improve the overall performance of the present street LED luminaire 10.

LEDs are very sensitive to heat. Heat must, therefore, be moved away from the LED junction 17 (that is, the solder junction of the diode 17a to the base substrate 17b) in order to maintain expected light output, lifespan and color. The LED junction temperature is the temperature at the point where an individual diode connects to its base. Poor control of the thermal management of LED junction temperature causes instability in the performance, luminous flux depreciation, color variation, shorter life and premature failures.

The amount of heat that can be removed depends upon the ambient temperature and the design of the thermal path from the LED junction 17 to the surroundings. Contrary to traditional luminaires where the housing is used only to protect the internal components, the thermal management of the LED arrays 16 is controlled via the integration of heat sinks 12 and other related structures into the housing 14 of the LED luminaire 10. The housing 14 is provided with integrated heat sinks 12, and considering all components of the present LED luminaire 10 are mounted within the housing 14, effective dissipation of heat produced by the LED arrays 16, and associated components, is achieved.

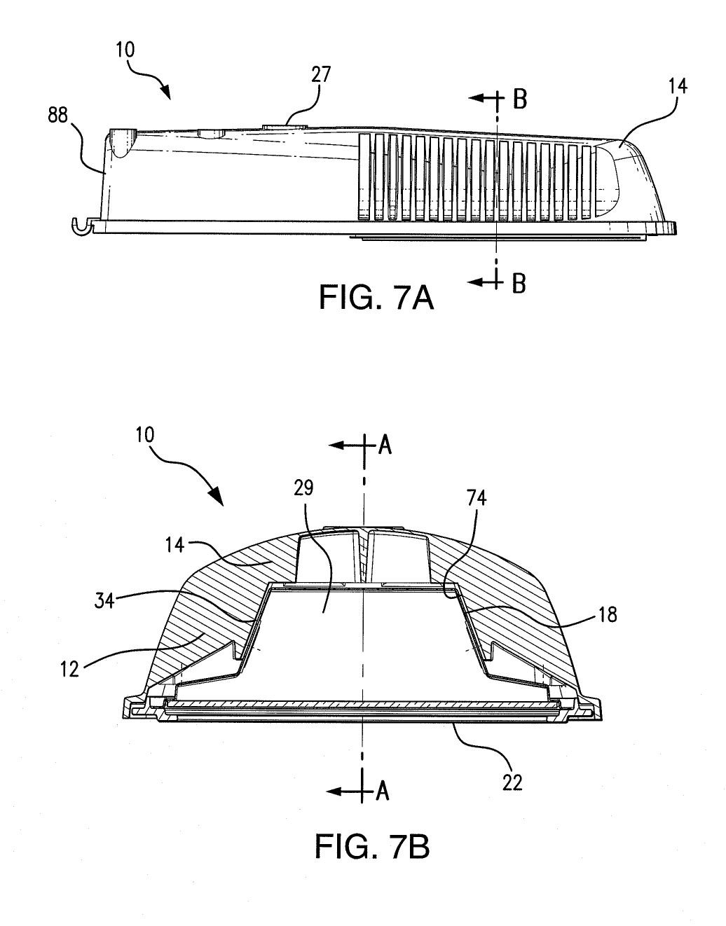

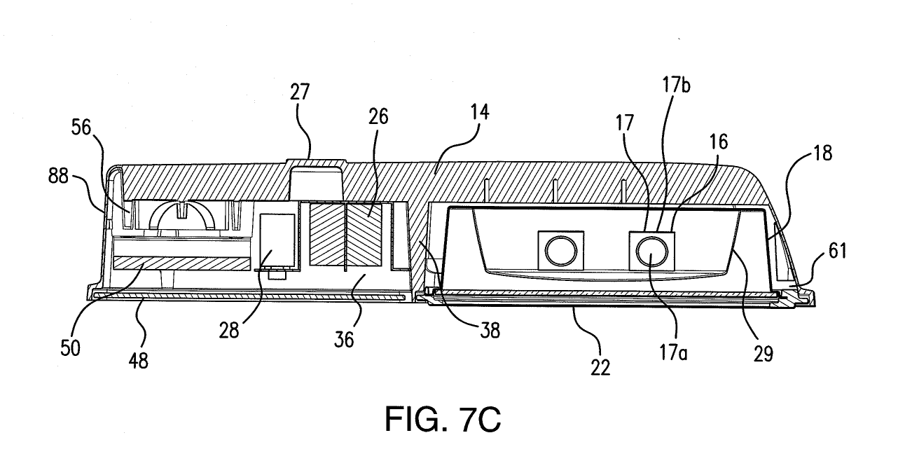

The LED arrays 16 are mounted within an optical chamber 29 that fits within the housing 14. The optical chamber 29 abuts the inner surface 64 of the heat sinks 12 for the effective transfer of heat thereto. More particularly, and with reference to FIGS. 7A-C and 9A-C, an aluminum V-shaped plate 72 is screwed, or otherwise secured, to the inner walls 74 of the housing 14 along the forward cavity section 34, which coincides with the inner surface 64 of the heat sinks 12. The plate 72 is substantially V-shaped so as to conform to the shape of the inner walls 74 of the housing 14 making up the forward cavity section 34. As such, the plate 72 includes a flat central member 76 with lateral plate walls 78, 80 extending downward therefrom. The plate 72 delimits the optical chamber.

The LED arrays 16 are screwed directly onto the apertures 82 formed in the flat central member 76 of the plate 72 and into apertures 84 formed in the upper wall 86 of the housing 14 so as to creating a facing relationship with the external vertical heat sinks 12. The angled portion of the plate 72, that is the lateral plate walls 78, 80 directly contact the LED arrays 16 to facilitate a good contact with the heat sinks 12 of the housing 14. In doing so, the result is an increase of the LEDs contact surface to the heat sinks 12 ultimately providing better heat transfer which leads to greater reliability and longer life of LED products.

It is appreciated, the present LED luminaire 10 uses the LED light source by way of a MULTI-CHIP MONOLED, which has and uses an optical and/or reflection chamber 29. The present LED luminaire 10 offers the following advantages: the optical chamber can be integrated in the LED luminaire 10 or an independent, interchangeable, and removable module; this optical chamber 29 is an airtight component that ranges from 0% to 100%, including a waterproof glass cover or protective optical lens; the optical chamber 29 is hermetically sealed which permits the management of air in the optical chamber 29. Furthermore, it has the capability to replace any gas or create a partial or complete vacuum in the optical/reflection chamber; the optical chamber may or may not include the low-emitting light source; the optical chamber may or may not include the heat sink of the light source (mechanical, electrical, electromechanical and hydro mechanical dissipater, all partly or completely); the optical chamber may or may not include the power source; the optical chamber includes a mandatory system of reflection, optical and glass or protective lens including an array of various components outlined above, namely: to include or not include the light source, the electrical source and the heat sink dissipater of the light source and/or electric.

### Housing

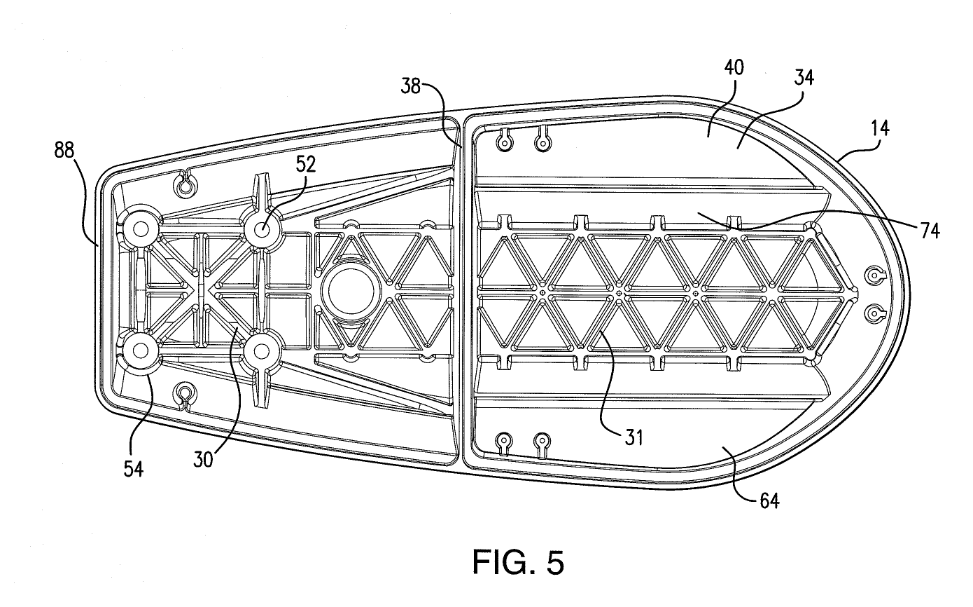

The housing 14 integrates important key structural and functional elements as shown in FIG. 5. The housing 14 is a general concave structure with a top wall 60 and downwardly extending side walls 62. The housing 14 may, therefore, generally be thought of as including a forward cavity section 34 housing the optical chamber 29, LED arrays 16, the optical system 20 and a high transmittance glass 22. The forward cavity section 34 of the housing 14 is separated from a rearward cavity section 36 by an optical separation wall 38. The clamping mechanism 24, the driver(s) 26, and the surge protector unit 28 are housed within the forward cavity section 34.

The rearward cavity section 36 is provided with rib lattice 30 and lateral reinforced wall section 32 to provide for the transfer of combined forces in three directions to the four point connection clamping mechanism 24 (see FIGS. 5, 6, 7A-C and 10B) used in securing the LED luminaire 10 to the support pole or mast. Similarly, the forward cavity section 36 is provided with rib lattice 31 to enhance the strength characteristics thereof.

The housing 14 and the cover 42 of the present street lighting LED luminaire 10 are preferably constructed of 22 ksi yield strength cast aluminum alloy. The housing 14 is structurally designed to resist 5 g forces, while all existing street lighting luminaires can resist to a maximum of 3 g. Such strength allows the installation of the present street lighting LED luminaire 10 in areas with harsh winds and the presence of frequent hurricanes.

Furthermore, the luminaire housing 14 is designed to optimize the thermal management of the LEDs arrays 16 via the integrated vertical heat sinks 12 integrated into the housing wall 40 surrounding the forward cavity section 34. The heats sinks 12 also function as structural elements to transfer load forces to the anchor system. The heat sinks 12 are structured as fins extending outwardly from the primary body of the housing 14. As such, the connected ends 13 of the heat sinks 12 share the inner walls 74 of the housing 14, allowing for effective heat transfer.

The vertical heat sinks 12 performance is validated via thermal simulation using computer software. Simulation results demonstrate that the number and the spacing between the heat sinks 12 were able to keep the LED junction temperature as low as possible and spread it over the entire housing 14 of the LED luminaire 10 allowing the heat to be readily transferred to the ambient air.

Several performance characteristics of the LED array products, including flux, forward voltage, color, and reliability are dependent upon LED junction temperature which is the highest temperature on the actual semiconductor in an electronic device. As the LED junction temperature increases, several performance parameters experience a temporary and recoverable shift. With increasing LED temperature, light output decreases, forward voltage (or V_{f}) decreases, and the color temperature shifts towards blue.

Since the LED junction temperature is the temperature at the light emission point at the heart of a LED device and it is not possible to measure the LED junction temperature, a case temperature is defined as a reference point. Exceeding the absolute maximum ratings irreversibly damage the LEDs and cause permanent shifts in performance.

As per the LED supplier used in the present street LED luminaire 10, the maximum case temperature of the LED array used in the present LED luminaire 10 is 105° C. with a maximum LED junction temperature of 150° C. It has been found by thermal simulation that thirty-four heat sinks 12 spaced approximately ¾ inch from each other is sufficient to operate the LEDs with a case temperature at 75° C. which is much lower than the 105° C. case temperature specified by the LED supplier. The thermal resistance of the heat sinks is about 0.5° C./W. Doing so, the efficient heat sinks 12 contributes to luminous efficacy of the LED luminaire 10 by maintaining the luminous flux output and lowering the input wattage and ensuring longer life.

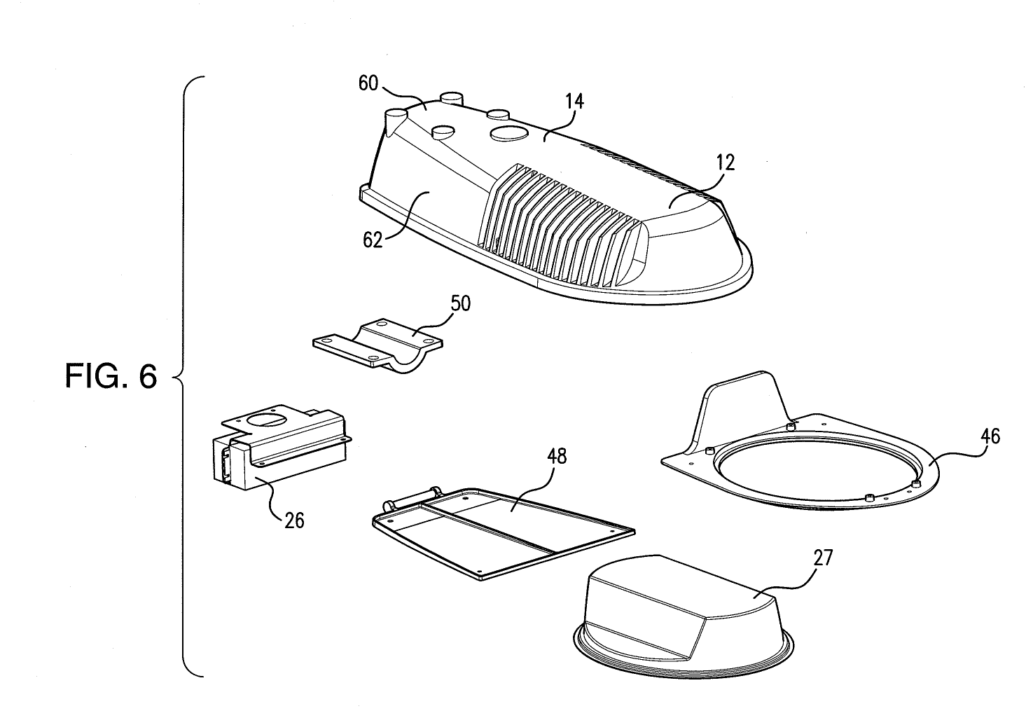

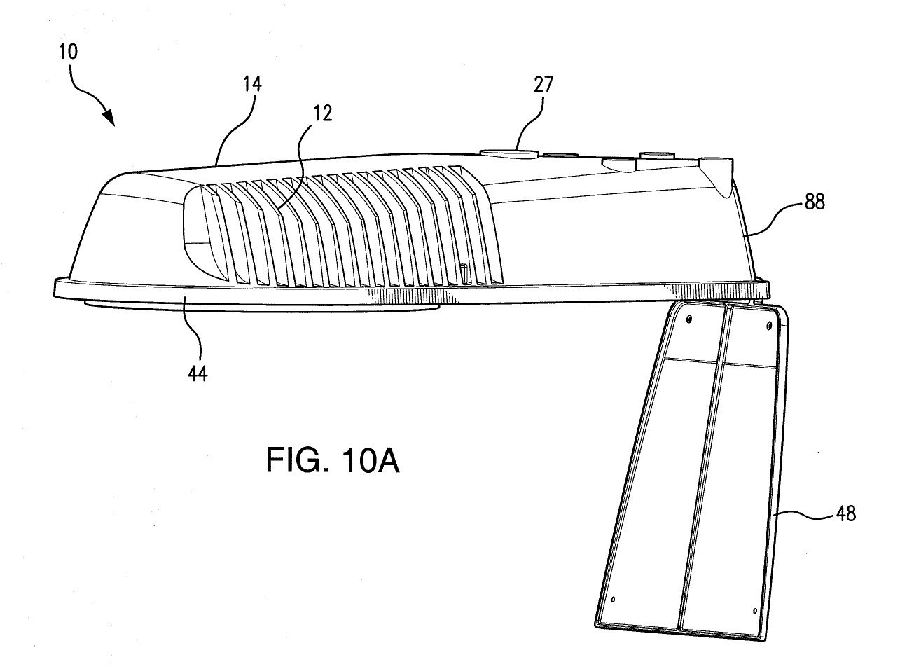

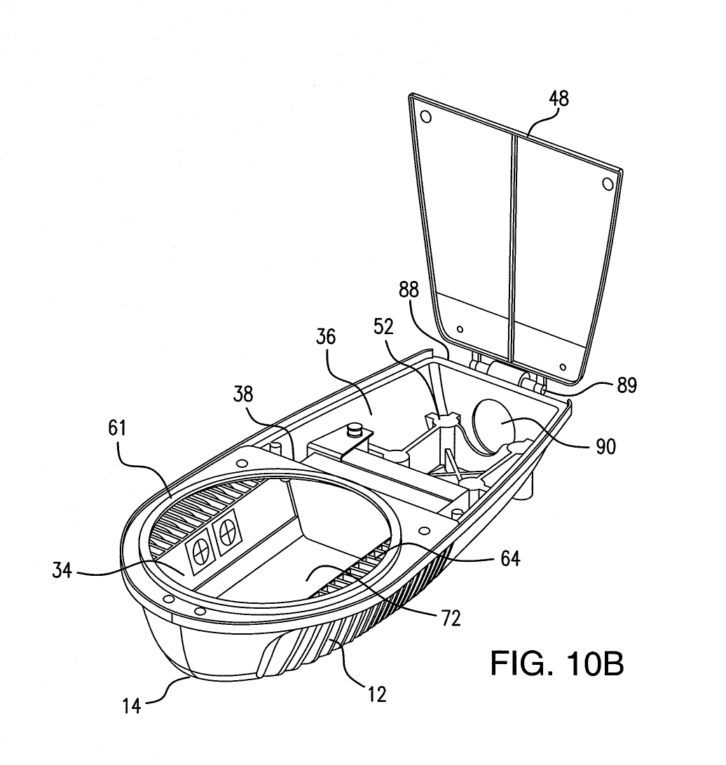

The cover 42 is used in selectively closing the open end 44 of the housing 14. The cover 42 is made in two separate die-cast aluminum parts as shown in FIGS. 6, 10A, and 10B. An optical door frame 46 is secured to the open end 44 of the housing 14 adjacent the forward cavity section 34 and is shaped and dimensioned for supporting the high transmittance glass lens 22. The second part of the cover 42 is a hinged door 48 which is secured to the open end 44 of the housing 14 adjacent the rear ward cavity section 36.

Referring to FIGS. 6, 10A and 10B, the hinged door 48 is a die-cast doorframe adapted for use as a service cover to enclose the electronic driver 26, the surge protector unit 28, the terminal block and the clamping system device. This hinged door 48 is pivotally secured to the end wall 88 of the housing 14 by way of a hinge 89 and provides access to the components mentioned above. The hinged door 48 is held closed by a series of captive screws (not shown) shaped and dimensioned for selective engagement with the housing 14 in order to allow its opening only by manual intervention. All mechanical parts used in the cover 42, that is, the optical door frame 46 and the hinged door 48, are resistant to corrosion. It is appreciated a safety wire guard may be used in connecting the hinged door 48 and the housing 14 to prevent accidental falling of the door in case of breakage of the hinges.

In this way, the optical door frame 46 and the hinged door 48 fully cover the forward and rearward cavity sections 34, 36 of the housing 14 and effectively seal the internal components of the LED luminaire 10 of the external environment. In accordance with a preferred embodiment, the optical door frame 46 and the hinged door 48 are secured to the housing 14 with screws.

### Clamping System

As discussed above, the present luminaire 10 also includes a versatile clamping mechanism 24 for attachment of the LED luminaire 10 to the support pole or mast. The housing 14, in the area of the rearward cavity section 36, provides bolting down cradle 52 details allowing the option for the use of alternate clamping mechanisms. Access to the bolting down cradle is provided with the provision of a mast aperture 90 in the end wall 88 of the housing 14. In accordance with a first embodiment, the clamping mechanism 24 uses a four bolt clamp down full size compression cover plate 50 which is secured to the bolting down cradle 52 formed along the inner wall 54 of the housing 14 in the rearward cavity section 36 with bolts 56 to hold to and connect to the post mast as shown in FIG. 6. The full size compression cover plate 50 provides improved non-loosening of the bolts 56 resulting from vibrations.

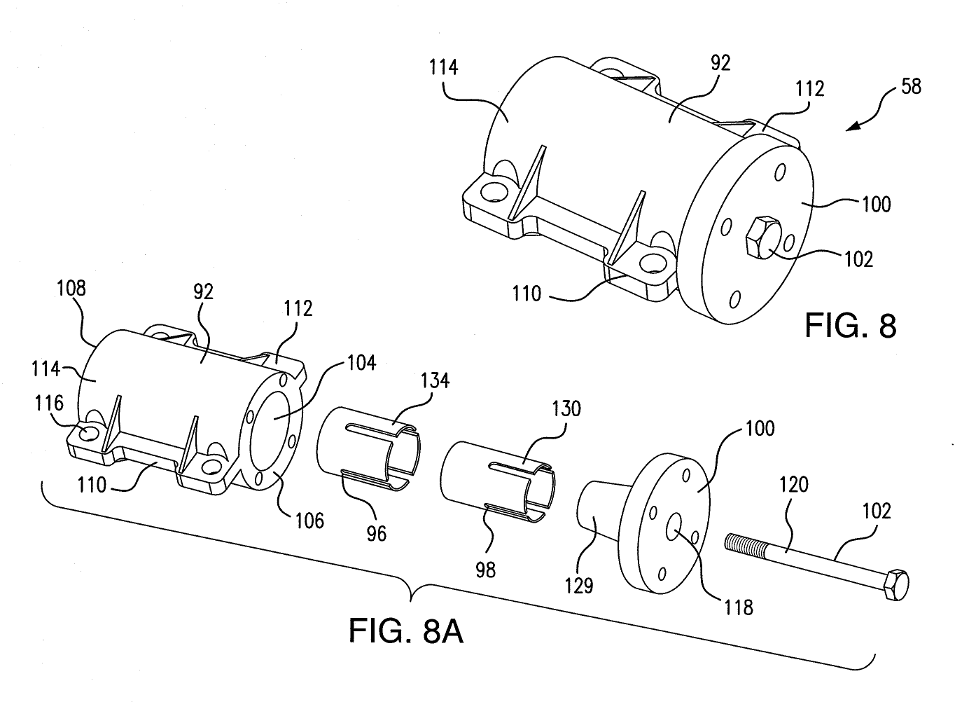

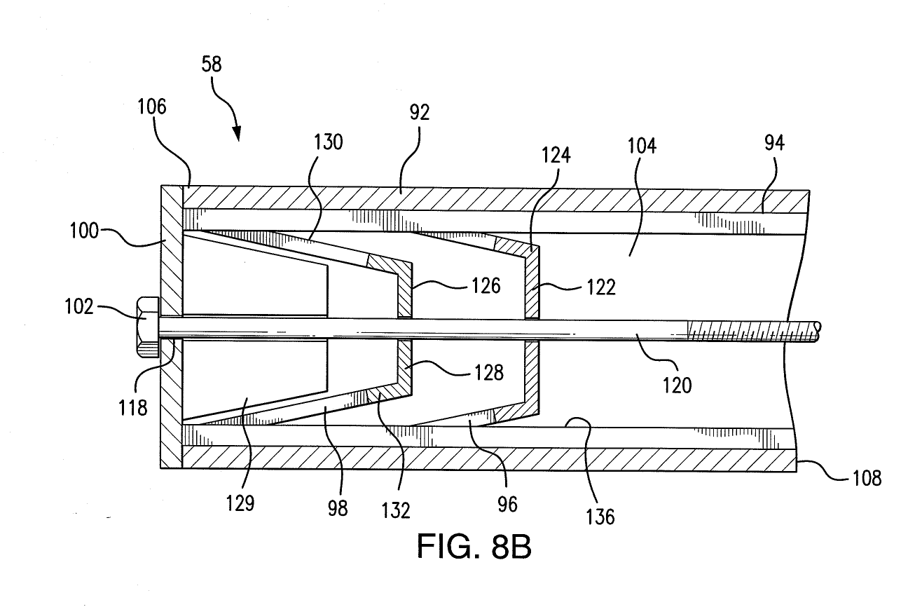

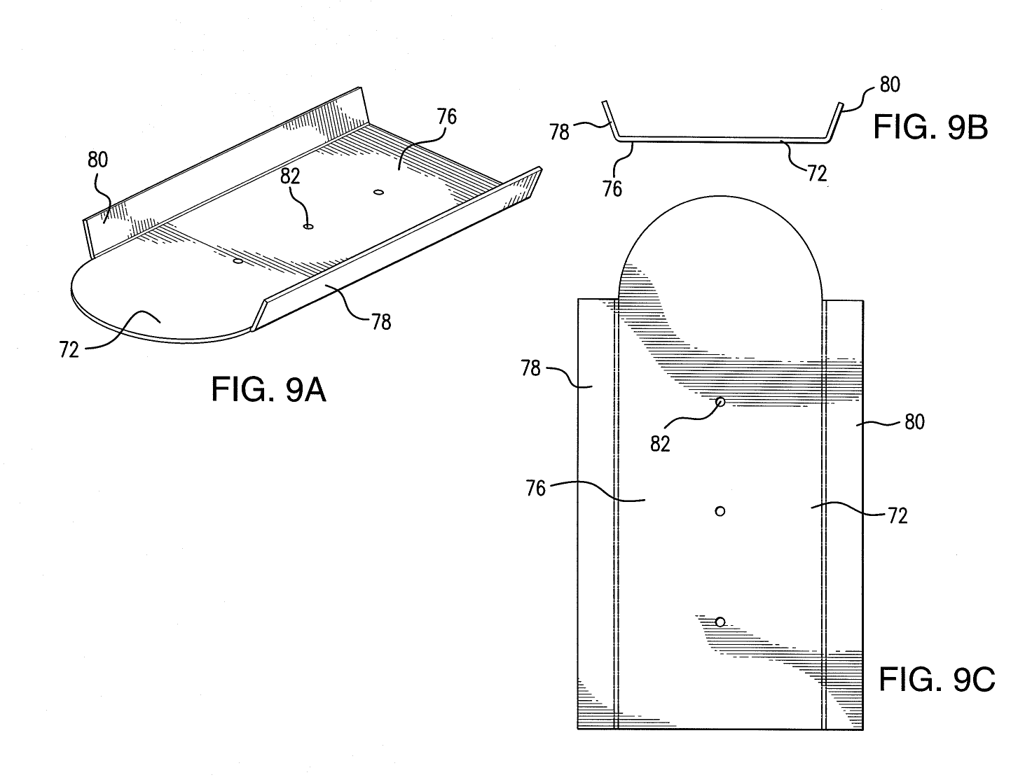

In accordance with a second embodiment, and with reference to FIGS. 8, 8A and 8B, the clamping mechanism 24 employs a non-slip compression-split mandrel 58 fitted into the inside diameter of the post mast 94, securing it within the main housing frame of the compression split mandrel 58. The compression fit provides improved non-slippage characteristics of components resulting from vibrations. The compression split mandrel 58 increases the resistance both in the level of rotation and in the extraction of the LED luminaire 10.

The fixation of a conventional street lighting luminaire to the support pole or mast is made using a clamping system combined with four stainless steel bolts. Since these luminaires are subject to external stresses such as vibrations and gusts of winds, such clamping systems are not designed to prevent tipping luminaires and rotation around the end of the post mast. Because the original positions of the luminaires have been breached, the lighting system is affected by either the averaged amount of light and/or the uniformity ratios in terms of maximum to minimum and average to minimum. This condition persists until the next service on the luminaire.

Regular maintenance visits are made to traditional street lighting every two or three year's maximum in order to change light bulbs and/or ballast components. With the advent of the present LED luminaire 10 such maintenance visits will be spaced in time and can be done over a period of up to 8 years. Such conditions require that the clamping system of LEDs street lighting luminaire is strengthened.

Referring to FIGS. 8, 8A and 8B, the 4-bolt anchorage base, or bolting down cradle 52 as disclosed above, of the luminaire housing 14 has been designed for facilitating attachment to a support pole or mast 94 either with a cover plate 50 type compression clamp as disclosed above or with a fully integrated non-slip compression-split mandrel 58 capable of anchoring the support pole or mast 94 by means of compression over its full length of and resisting static and 5 g dynamic vibration loads. The compression-split mandrel 58 is composed of a main housing frame 92, a rear first female split mandrel 96, a forward second female split mandrel 98, a traction mandrel 100 and compression screw 102. This attachment mechanism maintains the position of the LED luminaire 10 for on-site installations and prevents any form of rotation of the LED luminaire 10.

The main housing frame 92 is substantially cylindrical and includes a central opening 104 extending from the first end 106 thereof to the second end 108 thereof. Diametrically opposed mounting plates 110, 112 extend in opposite directions from the outer wall 114 of the main housing 92. The mounting plates 110, 112 include spaced apertures 116 shaped and dimensioned for receipt of bolts (not shown) used in securing the main housing frame 92 to the bolting down cradle 52 of the housing 14.

The rear first female split mandrel 96 and forward second female split mandrel 98 are expandable based upon the interaction between the traction mandrel 100, the compression screw 102, the rear first female split mandrel 96 and forward second female split mandrel 98. In particular, with the compression screw 102 passing through the central aperture 118 of the traction mandrel 100 the threaded end 120 of the compression screw 102 will engage a threaded cap 122 on the closed end 124 of the rear first female split mandrel 96 and a threaded cap 126 on the closed end 128 of the forward second female split mandrel 98 positioned between the rear first female split mandrel 96 and the traction mandrel 100. Upon rotation of the compression screw 102, and static positioning of the traction mandrel 100, the interaction of the threaded end 120 of the compression screw 102 and the threaded caps 122, 126 of the rear first female split mandrel 96 and the forward second female split mandrel 98 will cause the rear first female split mandrel 96 and the forward second female split mandrel 98 to be drawn toward the traction mandrel 100. As the forward second female split mandrel 98 approaches the frustoconical surface 129 of the traction mandrel 100, the fingers 130 of the forward second female split mandrel 98 will be forced to expand. Similar, as the rear first female split mandrel 96 approaches the frustoconical rear surface 132 of the forward second female split mandrel 98, the fingers 134 of the forward end of the rear first second female split mandrel 96 will be forced to expand. The expansion of the fingers 130, 134 of the rear first female split mandrel 96 and the forward second female split mandrel 98 provides for friction engagement with the inner wall 136 of the support pole or mast 94 in a manner securing the compression slip mandrel 58, and ultimately the luminaire, to the support pole or mast 94.

More particular, the central opening includes an internal diameter allowing the entry of the support pole or mast therein. Conventional support poles or masts are tubular with a hollow center. Once the support pole or mast is positioned within the central opening of the main housing frame, the rear first female split mandrel, forward second female split mandrel, traction mandrel and compression screw as assembled in the manner discussed above are positioned through the central opening in the second end of the main housing frame and within the hollow center of the post. The traction mandrel is then secured to the second end of main housing frame with bolts passing through apertures formed in the mounting plate of the traction mandrel and into apertures formed in the second end of the main housing frame.

With the traction mandrel securely mounted to the main housing frame, the compression screw is rotated in a manner causing the rear first mandrel and the forward second split female mandrel to be drawn toward the traction mandrel. As the forward second female split mandrel 98 approaches the frustoconical surface 129 of the traction mandrel 100, the fingers 130 of the forward second female split mandrel 98 will be forced to expand into frictional engagement with the inner wall of the post mast. Similar, as the rear first female split mandrel 96 approaches the frustoconical rear surface 132 of the forward second female split mandrel 98, the fingers 134 of the forward end of the rear first second female split mandrel 96 will be forced to expand into frictional engagement with the inner wall of the post mast. The expansion of the fingers 130, 134 of the rear first female split mandrel 96 and the forward second female split mandrel 98 provides for friction engagement with the inner wall 136 of the support pole or mast 94 in a manner securing the compression slip mandrel 58, and ultimately the luminaire, to the support pole or mast 94.

The compression of the first and second female split mandrels 96, 98 through the action of the compression screw 102 ensure that the support pole or mast 94 has been firmly secured and anchored at each end by the rear and forward female split mandrels 96, 98. Once the support pole or mast 94 is firmly secured, the compression split mandrel 58 will keep its compression resistance and keep the support pole or mast 94 from slippage due to vibration loads. It is appreciated the main housing frame of the compression split mandrel housing has also been designed for adaptation of chuck-type internal mandrel which will expand the post mast pipe against the walls of the housing over its full length to provide the necessary axial friction to resist the prescribed dynamic and vibration loads.

The use of this compression split mandrel allows for correction of the rotation of the street lighting luminaires subject to external stresses of vibrations and gusts of winds. That is why the clamping system of this present efficient street lighting luminaire is designed to withstand vibration forces of 5 g well as ANSI C136.1 requires that the maximum forces of 3 g.

### Optical System

MULTI-LED luminaires generally have several high-power LEDs grouped together and combined to collimators to attain the light levels needed for an application. This simplistic approach does not meet the basic principle of lighting which requires a punctual light source that can be controlled by a reflector, a refractor and/or diffuser. The main purpose of an optical system is to distribute the light according to a chosen pattern. The concept is to use the distribution of the light from a LED source of the MULTI-CHIP LED type by reflection (reflector, refractor or diffuser).

To do so, the components of the optical system of the present LED luminaire 10 are selected carefully to improve the overall efficacy of the present LED luminaire 10. The reflectors 18, which surround one side of the LED arrays 16, direct light through the high transmittance glass 22 secured along the open end of the optical door frame 44 and supported by the optical door frame 46. The reflectors 18 are fabricated using different materials with a different finish using the Alzak® process. This process is a special surface treatment for the production of bright and high reflective aluminum surfaces. The present LED luminaire 10 uses an optical system without the need for collimators. The LED luminaire 10 employs reflectors 18 (that may be fixed, moveable or interchangeable), a air-tight optical chamber 29, and an optical chamber 29 which could include the lighting source (MULTI-CHIP LED) and/or heat dissipater for the exchange source and/or source of electricity supply.

The present street lighting LED luminaire 10 emits no light above the horizon, that is, above the open end 44 of the housing 14 when the LED luminaire 10 is mounted and the high transmittance glass 22 is facing the ground. As such, the present LED luminaire 10 is classified as having a dark sky distribution. Since this street lighting LED luminaire 10 emits no light pollution, it is considered to be friendly with the environment. To achieve this kind of distribution, the high transmittance glass 22 is a high transmittance clear flat tempered glass lens.

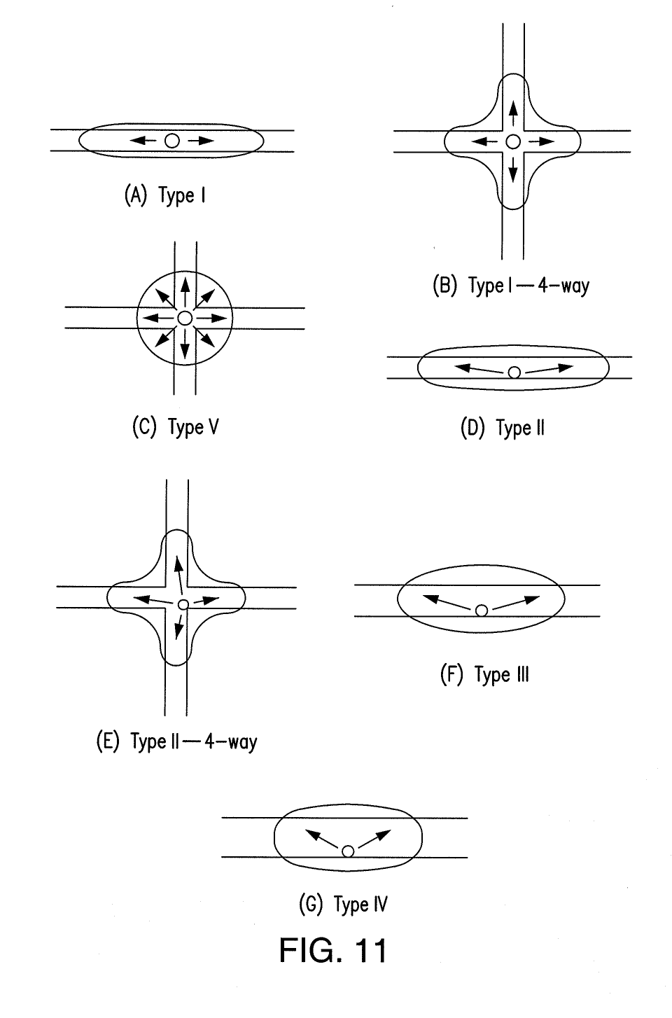

Asymmetrical Type I, Type II, Type III and Type IV distributions as shown in FIG. 11 are available for all wattages. These distributions are achieved through the controlled manufacture of the reflector with differing profiles. It is appreciated, the terms Type I, Type II, Type III, Type IV and Type V are used to qualify the lateral distribution of a street lighting luminaire. In general, we can say that a Type I distribution is used for narrow streets or one lane street, a Type II distribution for a two lanes road, a Type III distribution for a three lanes road, a Type IV in a for four lanes road or in parking lots. Distributions of Type I-4-Way and Type II-4-Way are rarely used today.

With such a diversity of distribution, lighting professionals can cover almost all types of street lighting applications. The choice of the distribution depends on the roadway width and the pole mounting height.

### IP Rating

The electrical components and optical system of a luminaire must be protected against water and dust to achieve a longer performance in time. This is achieved in accordance with the present invention through the use of a high transmittance glass lens 22 in conjunction with the housing 14, cover 42 and proper gasket 61. As lighting systems are exposed to outdoor elements, contaminates like dust, soot and moisture can collect on luminaire surfaces. When this happens to the optical system, the amount of light emitted from the fixture will be progressively reduced over time.

It is not uncommon for poorly sealed luminaires to experience infestation from dust, insects, water and even small birds building nests within their housings and optical chambers when they are not well sealed. Water from heavy storms with driving winds and rain can permeate optical chambers when they are not well sealed. Poor sealing of a luminaire causes malfunctions and performance losses resulting in greater energy waste because the higher percentage of luminaire dirt depreciation requires higher lamp wattages to obtain acceptable maintained lighting levels over time.

The vital aspect of luminaire performance imposes a profound influence on the percentage of Luminaire Dirt Depreciation (LLD) factor to apply in order to determine the overall Light Loss Factor (LLF). LLF depreciates initial lamp lumens to predict reduced light levels that will be maintained over time as the lamps age and luminaires get soiled. The amount of luminaire dirt depreciation is determined by the general environment where a lighting system is applied in conjunction with the ability of the luminaire to resist collecting dust, dirt and moisture on interior and exterior surfaces of the optical system.

The lighting industry uses the Ingress Protection (IP) rating to describe the ability of luminaire housings and optical systems to resist the penetration of solids and liquids. The present LED luminaire will have a high level and superior IP with respect to other luminaires on the market, because in order for the optical chamber, which incorporates the optical system, to maintain a vacuum it must be waterproof and sealed.

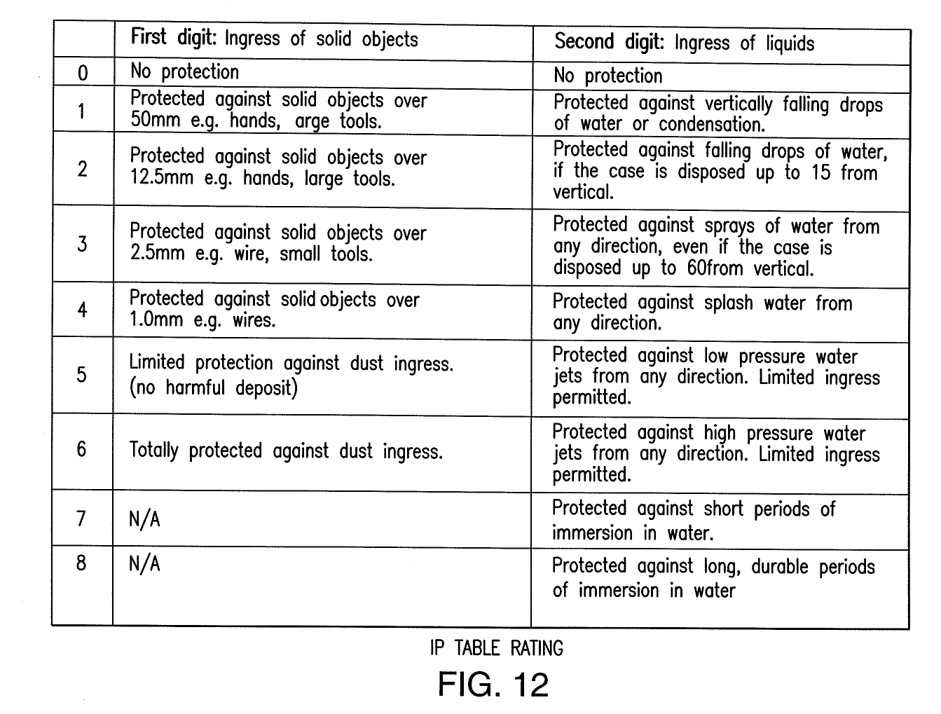

FIG. 12 explains the international standard IP rating nomenclature. The IP rating is followed by two numbers, e.g. IP65, where the numbers define the degree of protection. The first digit in the rating is the protection against solid objects. The minimum value of the first digit is 0 and the maximum value is 6. The second digit in the rating is the liquid protection factor with a minimum value of 0 and a maximum of 8.

Since all electrical components used in the power door are IP 66 ratings, the electrical compartment gear conserves the same IP rating by using proper gasket. The present luminaire incorporates a thick wall die-cast aluminum construction and channel set silicone gasketing to provide an IP66 optical chamber as shown in FIG. 6.

Since the optical system's performance is reduced by both dirt and water (or condensation) on lenses and reflecting elements, the IP rating of the optical system is one of the key element of the overall performance of a luminaire.

The optical wall barrier 38 separating the forward and rearward cavity sections 34, 36 optimizes the optical efficacy of the present LED luminaire 10 in even the harshest of environments. The first IP digit indicates dust intrusion. For a “6” rating, no talcum powder can penetrate the optical chamber, that is, the forward cavity section 34, meaning no dust and debris. The second digit indicates water intrusion, so with a second number of “6” that means no water can penetrate in the optical chamber.

A 10% luminaire dirt depreciation (LDD) is applied for luminaires rated IP55, however, with more energy-efficient optical systems rated IP66 as little as 2% LLD can be applied to the overall light loss factor for most outdoor environments. The ability of this luminaire to resist soil and moisture allows greater energy savings to be achieved by using lower lumen packages and fewer watts to maintain greater lighting levels over time.

### Electronic Driver

It is generally known that one of the weakest parts of an LED system is the LED driver due to the number and types of components they contain. Even if today's LED emitters can operate beyond 100,000 hours, the total LED systems reliability depends upon the weakest component within the system which is the electronic driver. In that sense, the LED driver is the most critical component of an LED luminaire.

The electronic driver 26 converts alternating current into direct current. This electrical device is mainly used to provide the proper electrical parameters to the LED arrays 16. An electronic driver is the equivalent of ballast for traditional light sources. There are many types of LED integrated circuits that can be used within the LED control system and many of them use different power circuit topologies mainly dependent upon the input and output voltage requirements of the LED drivers.

Two topologies offer a simple implementation: the buck topology and the boost topology. Both offer high efficiency over a wide range of electrical parameters. These two topologies achieve their effect in different ways, and these differences affect the efficiency with which they operate.

In the buck topology, the LED is placed in series with an inductor. This means that only a fraction of the energy has to pass through the inductor, the component which contributes a significant part of the losses. In this topology, the average current through the inductor is no more than the current through the LED.

In the boost topology configuration, all the energy passes through the inductor, as it is charged to ground and then discharged through the LED, averaged by a capacitor. In addition, the current through the inductor is higher than the current through the LED; losses increase with the square of the current. In practice, in a circuit with comparable power output, a typical boost regulator will deliver around 85% efficiency versus around 95% for a typical buck converter.

Unfortunately there is not one best way for driving LEDs. However, the majority of LED drivers use current mode switching techniques due to the high efficiencies, good accuracy of LED current regulation and wide system flexibility. The present luminaire uses commercial drivers manufactured by one of the leading driver manufacturers.

New methods are being developed by the inventors to design an intelligent electronic driver and to enable reliability testing of LED drivers by predicting the lifetime of electrolytic capacitors used within LED drivers. A well designed electronic driver must provide the proper operating current to the LEDs with a high power factor and must generate low total harmonic distortion.

Other functions will be added in a new intelligent monitoring and control system. The multi-chip used as a light source can be programmed for different operating wattages making adaptive light possible. The intelligent electronic driver will make it possible to lower the wattage and adapt it to the conditions of specific moment. The interference level between automobiles and pedestrians is not always the same on the same street at different periods of the night. By adapting or adjusting the lighting levels to the conditions of a specific moment, customers will save energy. It is appreciated it is possible to place two electronic drivers, permitting the second electronic driver to take over if the first electronic driver stops working. However, the present invention may make use of both electronic drivers at the same time, in turn, in order to avoid overheating of a single driver.

### Surge Protector

A surge protector unit 28 is used to provide protection against lightning strikes and other transient power surges. The surge protection device is designed to meet ANSI/IEEEC62.41-2002 for category C High. This specification requires the device to meet a 10 kA, 10 kV surge level. Competitive products offer 4-6 KV surge wave form to meet ANSI/IEEE62.41, category B protection. As a result, the present luminaire offers superior surge protection over competitive units. The device also provides noise filtering on the power line.

### Energy Efficient Product

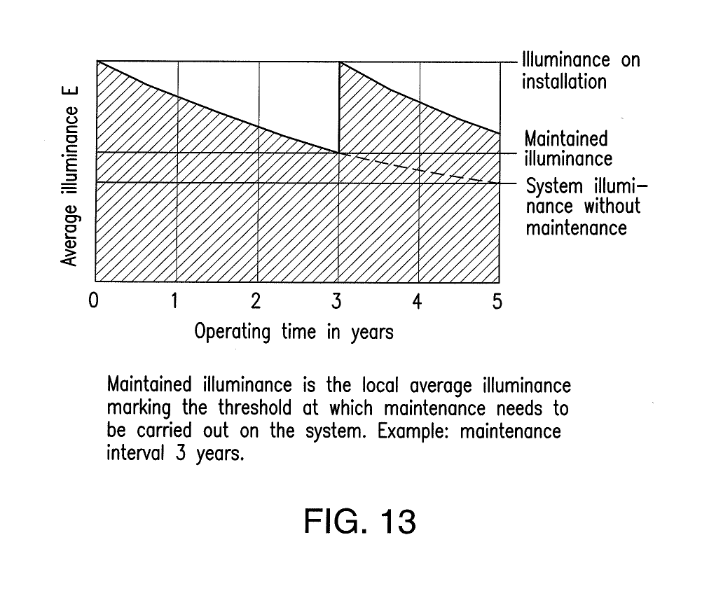

The present street lighting LED luminaire 10 also incorporates a new concept in solving the energy wasted from luminaire lumen depreciation. All luminaires lose light over time due to the overall light loss factor that includes the steady loss of light from light source aging, dirt accumulation, and luminaire materials degradation over the life of a product. The chart shown in FIG. 13 shows the depreciation of the illumination time for lighting systems with maintenance every three years and maintenance free.

The Illuminating Engineering Society of North America (IESNA) defines the lighting levels as a minimum maintained value for the execution of the visual task for the type of activity defined. Along the way, a number of operating and environmental conditions interfere with the transmission of light, resulting in wasted lumens. The lighting designer must provide a system that will take into account these conditions so that despite them the lighting system will provide proper quantity of light over time.

The light loss factors are captured as a metrics to perform the behavior of a lighting system installation and are divided in two types (non-recoverable, recoverable). The non-recoverable light loss generally does not affect the extent of the light loss. These include ballast factor, ambient luminaire temperature, supply voltage variation, optical factor and luminaire surface depreciation. The recoverable can reduce the extent of the light loss. These include lamp burnouts, lamp lumen depreciation (LLD), luminaire dirt depreciation (LLD).

Light loss factors are captured as percentages or decimals (example: 0.95), which are then multiplied to result in a final Light Loss Factor in lighting calculations.

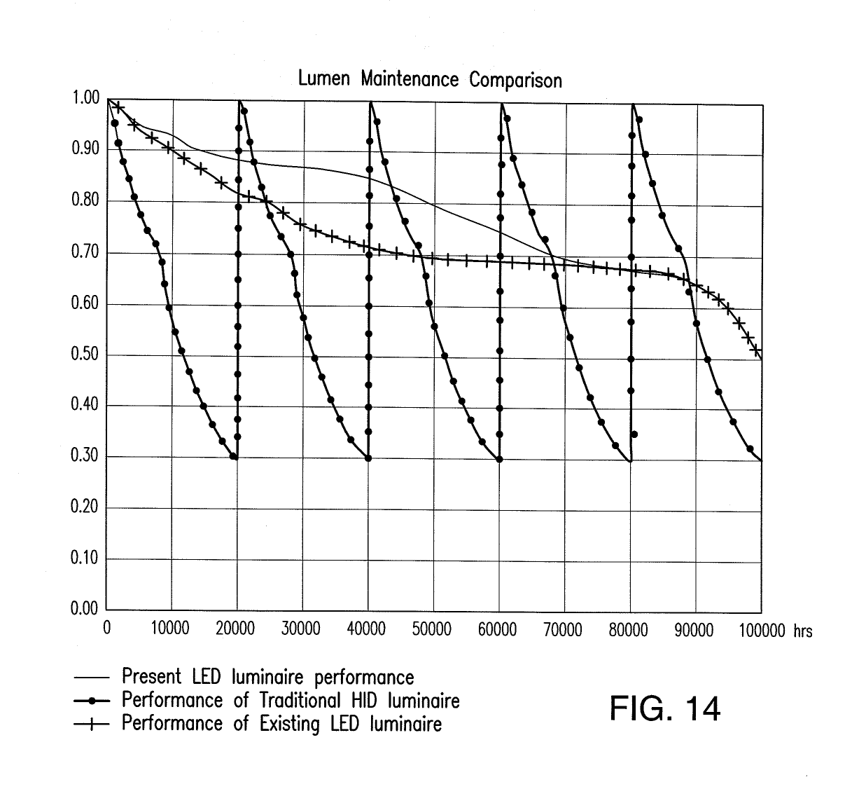

Any portion of light above the threshold maintained lighting levels generates the waste energy for lighting systems that do not offer the possibility of control as shown in FIG. 14.

Referring to FIG. 14, typically, lighting specifiers choose a point in time for operating a lighting system to calculate the accumulated losses in light from luminaire and light source degradation. For purposes of illustration, 70% of a rated lamp life is chosen. To accommodate losses to that point, a multiplier is used to determine initial lumens required for a new system. In this case, 20% more light is applied to accommodate the lumen depreciation of the lamp alone. This sets the amount of energy the system will consume over its entire life, even though light levels decline steadily.

With conventional lighting systems, light levels vary from over-lighting to under-lighting as lamps age and burn out. Over this time energy consumption remains unchanged from the initial over-lighting period. The result is a constant cycle of high and low light levels, while the energy consumed remains constant.

The cycling of light levels from over-illumination to under-illumination means that the lighting system is designed to consume a set amount of energy, while light levels fluctuate continuously over the life of lamps and luminaires. Because of this, each time the light level is higher than needed, energy is being wasted, while any time light levels fall below the design level, energy is wasted from producing less than desirable light output. Applying conventional calculation methods to LED lighting results in the same initial over-illumination with more wasted energy due to the fact the LED life is much longer than traditional light sources. Referring to FIG. 14, while the cycling of over and under illumination is significantly extended with the use of LED or solid-state products, lumen depreciation remains a factor in lighting design calculations, resulting in initial over-illumination to insure light levels are maintained over time, similar to conventional products. The result is a steady consumption of energy, producing a constantly depreciating light level.

By taking advantage of the electronic nature of the present street lighting LED luminaire 10, it is possible to constantly adjust power consumption to maintain a desired constant light level. The result is a continuous light level over the life of the system, with a significant savings in energy use.

Applying automatic power regulation to start a new system at a lower power level that is increased gradually over time to compensate for lumen depreciation, over-illumination is eliminated and energy is saved.

With this electronic driver 26, the present LED luminaire 10 will minimize the light loss factors by using programmed depreciation for diver current control. The only light loss factors to be included in lighting calculations are the luminaire dirt depreciation and any exceptional thermal conditions. The result is a constant delivery of a desired light level, and a significant saving in energy over time, by eliminating the waste of over-illumination.

In addition to saving energy and maintaining a desired design light level, operation of LEDs at a reduced current level extends the life of the system, delaying lumen depreciation significantly. This approach supports long LED life, constant light output, and delivers reduced energy consumption.

The lighting industry recommends that 70 percent lumen maintenance at 50,000 hours as a standard for LED sources in illumination applications. With its state of the art electronic driver 26 and the integrated heat sinks 12 in the housing 14 of the present street lighting LED luminaire 10, the present invention can push this limit to 85,000 hours of use. This street lighting consequently offers a lower maintenance cost, a longer LED life and a higher lumen output. This is achieved by keeping the LED junction temperature to a maximum of three quarter of the nominal value published by the LED manufacturer.

The heat sink 12 removes the concentrated heat of the LED junction, spreads it over a larger area and transfers it to the housing 14 and limits the LED junction temperature with sufficient lumens output to supply required lighting levels.

By mastering the LED luminaire technology through a good thermal management of the LED junction temperature with an IP66 optical chamber rating, optical systems that deliver the target lumens on the task, with a 5 g vibration resistance, the present energy efficient street lighting LED luminaire 10 offers a better performance in terms of electrical consumption and maintenance cost.

The present invention offers a LED luminaire with a platform that is flexible both at the manufacturing stage as well as at the time of maintenance or replacement. The purpose is to treat the emitting light source while managing the optical and/or reflection chamber in order to maximize its performance both in terms of its ability to provide light and its longevity and long-term sustainability.

The foregoing description of the exemplary embodiments of the invention has been presented only for the purposes of illustration and description and is not intended to be exhaustive or to limit the invention to the precise forms described.

Many modifications and variations are possible in the present street lighting luminaire of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope.

1. An energy-efficient street luminaire, comprising:
a luminaire housing including a heat sink in the form of outwardly extending fins integrally formed with the luminaire housing and abutting an LED junction.
an LED array housed within the luminaire housing;
an optical system with a high transmittance glass surrounding the LED array and the LED junction providing for the effective transmission of light generated by the LED array; and
an electronic driver coupled to the LED arrays for controlling the transmission of electricity thereto.

2. The luminaire according to claim 1, wherein the LED array and the LED junction are mounted within an optical chamber that fits within the luminaire housing.

3. The luminaire according to claim 2, wherein the LED junction in the optical chamber abuts the inner surface of the heat sink.

4. The luminaire according to claim 3, wherein the optical chamber includes an aluminum plate secured to an inner wall of the luminaire housing along a forward cavity section, which coincides with an inner surface of the heat sink.

5. The luminaire according to claim 4, wherein the aluminum plate conforms with a shape of the inner wall of the luminaire housing.

6. The luminaire according to claim 5, wherein the LED array and LED junction are screwed directly onto apertures formed in the aluminum plate and into apertures formed in the luminaire housing so as to creating a facing relationship with the heat sink.

7. The luminaire according to claim 2, wherein the optical chamber is an airtight component including a waterproof glass cover or protective optical lens.

8. The luminaire according to claim 2, wherein the optical chamber is hermetically sealed permitting management of air in the optical chamber.

9. The luminaire according to claim 1, wherein the LED array is a MULTICHIP MONOLED.

10. The luminaire according to claim 1, wherein the luminaire housing is a general concave structure with a top wall and downwardly extending side walls, and includes a forward cavity section housing an optical chamber, the LED array, the LED junction, the optical system and a high transmittance glass.

11. The luminaire according to claim 10, wherein the forward cavity section of the luminaire housing is separated from a rearward cavity section by an optical separation wall.

12. The luminaire according to claim 11, wherein the rearward cavity section is provided with rib lattice and lateral reinforced wall section.

13. The luminaire according to claim 12, wherein the rib lattice and lateral reinforced wall section provide for the transfer of combined forces in three directions to a clamping mechanism used in securing the luminaire to the support pole or mast.

14. The luminaire according to claim 12, wherein the forward cavity section is provided with rib lattice to enhance the strength characteristics thereof.

15. The luminaire according to claim 1, wherein the luminaire housing and a cover are constructed of 22 ksi yield strength cast aluminum alloy, resisting 5 g forces.

16. The luminaire according to claim 1, wherein the heat sink is structured as fins extending outwardly from a primary body of the luminaire housing, and connected ends of the fins share an inner wall of the luminaire housing allowing for effective heat transfer.

17. The luminaire according to claim 1, further including a cover made in two parts.

18. The luminaire according to claim 17, wherein the cover includes an optical door frame secured to an open end of the luminaire housing adjacent a forward cavity section of the housing and a hinged door secured to the open end of the luminaire housing adjacent the rearward cavity section, wherein the optical door frame and the hinged door fully cover forward and rearward cavity sections of the luminaire housing.
